(19) United States
(12) Patent Application Publication
(10) Pub. No.: US 2005/0043201 A1
(43) Pub. Date: Feb. 24, 2005

(54) Detergent composition

(75) Inventor: Prasanna Rao Dontula, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 10/920,476

(22) Filed: Aug. 18, 2004

(30) Foreign Application Priority Data
Aug. 18, 2003 (GB) 0319367.9

(51) Int. Cl. C11D 17/00

(52) U.S. Cl. 510/424; 510/444

(57) ABSTRACT

A surfactant blend that is solid at room temperature for use in manufacturing a detergent composition, preferably a particulate detergent composition, is provided. Specifically a surfactant blend which comprises at least 50 wt % of soap and non-soap surfactant, wherein the carbon chain of the soap is not a saturated straight chain, preferably the carbon chain is branched and/or unsaturated and the blend comprises at least 40 wt % of anionic and nonionic surfactant in a weight ratio of 3:1 to 1:3.

### TECHNICAL FIELD

The present invention relates to a surfactant blend for use in manufacturing a detergent composition.

### BACKGROUND AND PRIOR ART

Modern detergent compositions often contain more than one type of surfactant.

Often surfactants are manufactured together as a blend of surfactants. Such blends can provide further advantages such as ease of handling. A common component of surfactant blends are salts of straight-chain saturated fatty acids, commonly known as soap. Use of such soaps helps to structure the blend and make the blends less sticky at room temperature. However one concomitant disadvantage is that the melting temperature of the blend usually rises as a result. Often this rise in melting temperature necessitates that the surfactant blend requires heating in order for it to be poured or pumped in a detergent manufacturing process.

EP 00 38 591 discloses a detergent composition which may contain 1-20% of anionic and nonionic surfactants and up to 60% of a water-soluble soap of unsaturated fatty acids. Thus the maximum level of surfactant can theoretically be as high as 80%. In practice such levels are not achieved.

WO 98/11198 discloses a surfactant blend comprising anionic sulphonate surfactant, ethoxylated nonionic surfactant and a C₁₆-C₁₈ soap.

The present inventors have surprisingly found that if a soap which is not the normally used straight-chain saturated soap is used then the surfactant blend is structured at room temperature, reducing its stickiness, whilst the melting temperature of the surfactant blend is surprisingly low compared with surfactant blends not containing such an unsaturated and/or branched soap.

Thus a first aspect of the invention provides a surfactant blend that is solid at room temperature which comprises at least 50 wt % of soap and non-soap surfactant, wherein the carbon chain of the soap is not a saturated straight chain.

A second aspect of the invention provides a process for the preparation of a particulate or granular detergent composition or component which comprises mixing the surfactant blend with one or more particulate carrier materials.

### DETAILED DESCRIPTION OF THE INVENTION

The soap

The soap is derived from a fatty acid and may be neutralised to form an alkali metal or alkaline earth metal salt with any suitable neutralising agent. The sodium salt is preferred. Suitably the fatty acid contains from 12 to 20 carbon atoms in its carbon chain. The carbon chain is either branched or comprises at least one unsaturated carbon double bond. Suitable commercially available fatty acids are available under the Prisorine (Trade Mark) or Priolene (Trade Mark) brand name from Uniqema. Preferably the blend comprises from 0.1 to 50 wt % of the branched or unsaturated soap, preferably from 0.5 to 30 wt %, more preferably from 1 to 10 wt %.

In one embodiment the blend further comprises a soap having a straight carbon chain which is saturated, preferably from 0.1 to 30 wt %, more preferably from 0.5 to 20 wt %, most preferably from 1 to 10 wt %.

The Surfactant Blend

The present invention is concerned with blends of surfactants that are solid (structured) at room temperature. Such a blend is characterised by the presence of at least 50% surfactant, preferably at least 60 wt %, more preferably at last 70 wt %, or even more than 80 wt %.

Detergent-active compounds (surfactants) may be chosen from soap and non-soap anionic, cationic, nonionic, amphoteric and zwitterionic detergent-active compounds, and mixtures thereof. Many suitable detergent-active compounds are available and are fully described in the literature, for example, in “Surface-Active Agents and Detergents”, Volumes I and II, by Schwartz, Perry and Berch.

The blend contains anionic surfactant and preferably this is a sulphate or sulphonate type surfactant. Examples include alkylbenzene sulphonates, particularly linear alkylbenzene sulphonates having an alkyl chain length of C₈-C₁₅; primary and secondary alkylsulphates, particularly C₈-C₂₀ primary alkyl sulphates; alkyl ether sulphates; olefin sulphonates; alkyl xylene sulphonates; dialkyl sulphosuccinates; and fatty acid ester sulphonates. Sodium salts are generally preferred. Preferably the anionic surfactant is a C₈-C₁₆, preferably C₁₂-C₁₄, alkyl benzene sulphonate. Preferably the blend comprises from 5 to 70 wt % anionic surfactant, more preferably from 10 to 60 wt %, most preferably from 20 to 50 wt %.

The surfactant blend also comprises nonionic surfactant. Preferably this is a primary or secondary alcohol ethoxylate, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide). Preferably the blend comprises from 5 to 70 wt % nonionic surfactant, more preferably from 10 to 60 wt %, most preferably from 20 to 50 wt %.

Cationic surfactants that may be used include quaternary ammonium salts of the general formula R₁R₂R₃R₄N⁺X⁻ wherein the R groups are long or short hydrocarbyl chains, typically alkyl, hydroxyalkyl or ethoxylated alkyl groups, and X is a solubilising anion (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, chorine esters). If present Preferably the blend comprises from 5 to 70 wt % anionic surfactant, more preferably from 10 to 60 wt %, most preferably from 20 to 50 wt %.

Amphoteric and zwitterionic surfactants that may be used include alkyl amine oxides, betaines and sulphobetaines. In accordance with the present invention, the detergent surfactant (a) most preferably comprises an anionic sulphonate or sulphonate surfactant optionally in admixture with one or more cosurfactants selected from ethoxylated nonionic surfactants, non-ethoxylated nonionic surfactants, ethoxylated sulphate anionic surfactants, cationic surfactants, amine oxides, alkanolamides and combinations thereof.

The surfactant blend comprises both anionic and nonionic surfactant and the weight ratio of anionic surfactant to nonionic surfactant is in the range of from 3:1 to 1:3, preferably from 2:1 to 1:2.

Preferably the blend has a melting point of 80° C. or less, preferably 70° C. or less, more preferably 60° C. or less. A lower melting point means that the blend is easier to process because it requires less heating or none at all. The blend may contain other materials as structurants but these will generally be present in a minor amount.

Use of the Blend

The blend is intended for use in a process for manufacturing a particulate laundry detergent composition. For example the blend can be used in a process for the preparation of a particulate or granular detergent composition or component which comprises mixing the surfactant blend with one or more particulate carrier materials.

A suitable process involves the use of a mechanical granulator. Preferably, this is of a type having moving impellers and preferably cutters. Suitable such granulators include a high speed mixer/granulator such as a Lodige® CB machine or a moderate-speed mixer such as a Lodige® KM machine. Other suitable equipment includes Drais® T160 series manufactured by Drais Werke GmbH, Germany; the Littleford mixer with internal chopping blades and turbine-type miller mixer having several blades on an axis of rotation. A low- or high-shear mixer granulator often has a stirring action and/or a cutting action which are operated independently of one another. Preferred types of low- or high-shear mixer granulators are mixers of the Fukae® FS-G series; Diosna® V series ex Dierks & Sohne, Germany; Pharma Matrix® ex. T.K. Fielder Ltd, England. Other mixers which are suitable for use in the process of the invention are Fuji® VG-C series ex Fuji Sangyo Co., Japan; the Roto® ex Zanchetta & Co. srl, Italy and Schugi® Flexomix granulator. Yet another suitable mixer is the Lodige (Trade Mark) FM series (ploughshare mixers) batch mixer ex Morton Machine Col Ltd., Scotland.

Another suitable apparatus is the use of a low shear granulator.

A preferred low shear granulator is one of the gas fluidisation type, which comprises a fluidisation zone in which the surfactant blend is sprayed into or onto the particulate carrier material. However, a low shear bowl mixer/granulator can also be used. When the low shear granulator is of the gas fluidisation kind it may sometimes be preferable to use equipment of the kind provided with a vibrating bed.

If the low-shear granulator is of the gas fluidisation kind, then the surfactant blend can be sprayed from above and/or below and/or within the midst of the fluidised material comprising the particulate carrier material.

If a gas fluidisation granulator is used as the low-shear granulator, then preferably it is operated at a superficial air velocity of about 0.1-2.0 ms⁻¹, either under positive or negative relative pressure and with an air inlet temperature ranging from −10° or 5° C. up to 80° C., or in some cases, up to 200° C. An operational temperature inside the bed of from ambient temperature to 60° C. is typical. Depending on the process, it may be advantageous to vary the temperature (upwardly and/or downwards, during at least part of the process).

A low-shear granulator used in the process of the present invention may be adapted to recycle “fines”, i.e. powdered or part-granular material of vary small particle size, so that they are returned to the input of the low shear granulator and/or input of any pre-mixer/granulator. Preferably the fine particulates are elutriated material, e.g. they are present in the air leaving a gas fluidisation chamber.

It is preferred to operate the fluidised bed granulator such that solid material is contacted with a spray of the liquid components to meet the requirement that the excess velocity (Uₑ) of fluidisation gas relative to the mass or volume flux of the spray (q_{mliq} or q_{vliq}) when determined at the normalised nozzle-to-bed distance (D₀) is set so that the flux number (FNₘ or FNᵥ) as determined by

$${FN}_{m} = {log}_{10} [ \frac{{ρ}_{p} {U}_{e}}{{q}_{mliq}} ] \qquad OR \qquad {FN}_{v} = {log}_{10} [ \frac{{U}_{e}}{{q}_{vliq}} ]$$

(where ρₚ is the particle density) is at a critical value of at least 2 for at least 30% of the process.

It is also preferred that d_{3,2} average droplet diameter of the liquid binder dosed in step (ii) is not greater than ten times the d_{3,2} average particle diameter of that fraction of the solids which has a d_{3,2} particle diameter of from 20 μm to 200 μm, provided that if more than 90% by weight of the solid starting material has a d_{3,2} average particle diameter less than 20 μm then the d_{3,2} average particle diameter of the total solid starting materials shall be taken to be 20 μm. If more than 90% by weight of the solid starting material has a d_{3,2} average particle diameter greater than 200 μm than the d_{3,2} average particle diameter of the total starting solid material shall be taken to be 200 μm.

Produced Detergent Compositions

Use of the surfactant blend will enable a more efficient production of particulate laundry detergent compositions.

### EXAMPLES

Mixtures of alkylbenzene sulphonic acid, non-ionic 7EO and different fatty acid mixtures were neutralised by slowly adding an aqueous 50% by weight sodium hydroxide solution. The amount added was less than 10% by weight in excess of that needed to neutralise the alkylbenzene sulphonic acid and the fatty acid based on stiochiometric calculations. Blend solidification temperatures (melting points) reported are the onset temperature of the peak in the endotherm by using a DSC. Peak temperatures are rounded off to the nearest degree Celsius. The cooling rate employed was 10° C./min. The fatty acid used to prepare the reference structured blends is a commercial mixture comprising mainly palmitic and stearic acids (Pristerine (Trade Mark) 4916, ex-Uniquema). Iso-stearic acid of technical grade was supplied as Prisorine (Trade Mark) 3508 by Uniquema. Oleic acid was supplied as Priolene (Trade Mark) 6907 by Uniquema.

TABLE 1

| | | | Sodium Salt | Sodium Salt | |
|---|---|---|---|---|---|
| | | | of | of | |
| | | | Pristerine | Prisorine | Melting Point, |
| Example | NaLAS | NI | 4916 | 3508 | ° C. |
| A | 52.94 | 35.29 | 11.77 | 0 | 87 |
| B | 47.8 | 39.2 | 13.1 | 0.0 | 87 |
| C | 42.9 | 42.9 | 14.3 | 0.0 | 89 |
| D | 38.1 | 46.4 | 15.5 | 0.0 | 93 |
| 1 | 50.94 | 33.96 | 11.32 | 3.78 | Not measured |
| 2 | 45.8 | 37.5 | 12.5 | 4.2 | 66 |
| 3 | 40.9 | 40.9 | 13.6 | 4.5 | 72 |
| 4 | 36.2 | 44.2 | 14.7 | 4.9 | 78 |
| 5 | 47.37 | 31.58 | 10.53 | 10.52 | 60 |
| 6 | 42.3 | 34.6 | 11.5 | 11.5 | 63 |
| 7 | 37.5 | 37.5 | 12.5 | 12.5 | 72 |
| 8 | 33.0 | 40.2 | 13.4 | 13.4 | 71 |

TABLE 2

| | | | Sodium Salt | Sodium Salt | |
|---|---|---|---|---|---|
| | | | of | of | |
| | | | Pristerine | Prisorine | |
| Example | NaLAS | NI | 4916 | 3508 | Melting Point |
| E | 56.1 | 37.6 | 6.3 | 0.0 | 75 |
| F | 51.1 | 41.9 | 7.0 | 0.0 | 76 |
| G | 46.2 | 46.2 | 7.7 | 0.0 | 79 |
| H | 41.3 | 50.3 | 8.4 | 0.0 | 84 |
| I | 36.4 | 54.5 | 9.1 | 0.0 | 89 |
| 9 | 55.0 | 36.8 | 6.1 | 2.0 | Not measured |
| 10 | 49.9 | 41.0 | 6.8 | 2.3 | 52 |
| 11 | 45.0 | 45.0 | 7.5 | 2.5 | 62 |
| 12 | 40.1 | 49.0 | 8.2 | 2.7 | 66 |
| 13 | 35.3 | 52.9 | 8.8 | 2.9 | 72 |
| 14 | 52.8 | 35.4 | 5.9 | 5.9 | 46 |
| 15 | 47.8 | 39.2 | 6.5 | 6.5 | 53 |
| 16 | 42.9 | 42.9 | 7.1 | 7.1 | 56 |
| 17 | 38.1 | 46.4 | 7.7 | 7.7 | 64 |
| 18 | 33.3 | 50.0 | 8.3 | 8.3 | 68 |

TABLE 3

| | | | Sodium Salt | Sodium Salt | Sodium | |
|---|---|---|---|---|---|---|
| | | | of | of | Salt of | |
| Exam- | | | Pristerine | Prisorine | Priolene | Melting |
| ple | NaLAS | NI | 4916 | 3508 | 6907 | Point |
| J | 37.5 | 46.9 | 15.6 | — | — | 81.4 |
| 19 | 34.8 | 43.5 | 14.5 | 7.2 | — | 52.2 |
| 20 | 34.8 | 43.5 | 14.5 | — | 7.2 | 54.7 |

1. A surfactant blend that is solid at room temperature which comprises at least 50 wt % of soap and non-soap surfactant, wherein the non-soap surfactant comprises at least 40 wt % of anionic surfactant and nonionic surfactant in a weight ratio of 3:1 to 1:3, characterised in that the soap comprises at least one soap selected from the group of soaps with a branched carbon chain and soaps having a carbon chain with at least one unsaturated carbon double bond.

2. A surfactant blend as claimed in claim 1, wherein the carbon chain is a branched chain.

3. A surfactant blend as claimed in claim 1, wherein the carbon chain has at least one unsaturated carbon double bond.

4. A surfactant blend as claimed in claim 1, which comprises from 5 to 70 wt % anionic surfactant, preferably from 10 to 60 wt %, most preferably from 20 to 50 wt %.

5. A surfactant blend as claimed in claim 4, which comprises a sulphonate type surfactant.

6. A surfactant blend as claimed in claim 5, which comprises C₈-C₁₆, preferably C₁₂-C₁₄, alkyl benzene sulphonate.

7. A surfactant blend as claimed in claim 1, which comprises from 5 to 70 wt % nonionic surfactant, preferably from 10 to 60 wt %, most preferably from 20 to 50 wt %.

8. A surfactant blend as claimed in claim 1, which comprises from 0.1 to 50 wt % of the soap, preferably from 0.5 to 30 wt %, more preferably from 1 to 10 wt %.

9. A surfactant blend as claimed in claim 8, which also comprises a soap having a straight carbon chain which is saturated, preferably from 0.1 to 30 wt %, more preferably from 0.5 to 20 wt %, most preferably from 1 to 10 wt %.

10. A surfactant blend as claimed in claim 1 which has a melting point of 80° C. or less, preferably 70° C. or less, more preferably 60° C. or less.

11. A process for the preparation of a particulate or granular detergent composition or component which comprises mixing a surfactant blend as claimed in claim 1 with one or more particulate carrier materials.
